(19) United States
(12) Patent Application Publication
(10) Pub. No.: US 2007/0002596 A1
(43) Pub. Date: Jan. 4, 2007

(54) Two-stage, wide range power supply for a network protector control relay

(75) Inventors: Thomas J. Kenny, Pittsburgh, PA (US); Joseph C. Engel, Monroeville, PA (US)

Correspondence Address: MARTIN J. MORAN, ESQ.;Eaton Electrical, Inc.,, Technology & Quality Center, RIDC Park West, 170 Industry Drive, Pittsburgh, PA, 15275-1032, US

(73) Assignee: EATON CORPORATION

(21) Appl. No.: 11/170,658

(22) Filed: Jun. 29, 2005

(51) Int. Cl. H02M 7/04

(52) U.S. Cl. 363/89

(57) ABSTRACT

A power supply for a control relay includes first and second voltage regulators having first and second operating ranges, respectively, and a switching mechanism. A rectified DC source voltage is provided to the first voltage regulator and the first voltage regulator converts it into a first DC voltage. The rectified DC source voltage is also provided to the switching mechanism which provides it to the second voltage regulator only when the switching mechanism is in a second condition. When the second voltage regulator receives the rectified DC source voltage, it converts it into a second DC voltage. The switching mechanism is adapted to be in a first condition when the rectified DC source voltage is greater than an upper threshold of the second operating range and in the second condition when the rectified DC source voltage is less than that upper threshold. At least one of the DC voltages is provided to the control relay.

### BACKGROUND OF THE INVENTION

1. Field of the Invention

The present invention relates to power supplies for network protector control relays, and in particular to a two-stage power supply for a network protector control relay that is capable of providing power to a network protector control relay over a wide operating range (a wide range of input voltage levels).

2. Description of the Prior Art

Network protector control relays are installed in electric power transmission and distribution facilities to detect overloads, short circuits, and other fault conditions. They are connected to power circuit breakers or switching devices that disconnect the faulty portion of the network on command from the relay to isolate the problem. Reliable operation of relays is especially critical during short circuit faults, which must be rapidly isolated to minimize damage to equipment and the risk of fire and injury of personnel.

Overcurrent network protector control relays typically monitor the current load within a circuit downstream of a circuit breaker through current transformers which communicate with each phase of the monitored circuit. The control relay monitors the time-current characteristics of the load through which it senses short circuit faults or overloads on the feeder circuit and trips the circuit breaker to disconnect the faulty feeder from the bus, which normally also supplies other feeders.

Modern network protector control relays are electronic, typically employing microprocessors, electronic displays, and data communications ports to exchange operating information with a central facility control system. The relays normally supply operating information, including load measurements, demand values, and circuit status to the control center. They require continuous power to perform these functions, as well as protection tasks during faults. For system voltages (line to line) greater than 216 Vac, the relays are commonly energized from a control power transformer connected to either or both of the monitored circuit (the network) or a feeder system transformer between phases or from a phase to neutral. The control power transformer steps the power voltage down to a safe level suitable for the relay power supply input. For 216 Vac systems, the network relay is directly connected to the protector power busses.

As will be appreciated, it is important for network protector control relays to function at all of the possible operating voltages of the network that it is protecting. As a result, the power supply for the network protector control relay must be able to operate over the same operating range in order to ensure that the network protector control relay will always have sufficient power to operate. This constitutes a relatively wide dynamic operating range relative to typical power supply designs. For example, a power supply operating range for an industrial electronic device is commonly +/−20% range of the nominal input voltage potential. Power supply designs considered to be wide range can extend this to a +/−40% operating range from nominal conditions. For a network protector relay, the necessary range is significantly larger still at approximately +50%/−90% of nominal. For a nominal 125 Vac L-N relay input voltage from a three phase system, an operating range of approximately 13 Vac L-N to 188 Vac L-N is implied. There are, however, situations in which the power supply for a network protector control relay is required to operate over an even wider operating range. For example, one situation is if one or at worst case two of the three power busses become de-energized in combination with the stated +50%/−90% input range on the remaining power bus. Current prior art power supplies are unable to operate over such a wide range of input voltages. Thus, there is a need for a power supply for a network protector control relay that is able to safely and effectively operate over the extreme wide operating range that could not be handled by existing power supplies.

### SUMMARY OF THE INVENTION

These and other advantages are provided by a power supply for a network protector control relay that includes a first voltage regulator, a second voltage regulator and a switching mechanism. The first voltage regulator has a first operating range having a first lower threshold and a first upper threshold. A rectified DC source voltage is provided to the first voltage regulator and the first voltage regulator converts the rectified DC source voltage into a first DC voltage. The switching mechanism has a first condition and a second condition. The rectified DC source voltage is provided to the switching mechanism. The second voltage regulator has a second operating range having a second lower threshold and a second upper threshold, and is operatively coupled to the switching mechanism. The rectified DC source voltage is provided to the second voltage regulator when the switching mechanism is in the second condition and is not provided to the second voltage regulator when the switching mechanism is in the first condition. When the second voltage regulator receives the rectified DC source voltage, it converts it into a second DC voltage. The switching mechanism is adapted to be in the first condition when the rectified DC source voltage is greater than the second upper threshold and in the second condition when the rectified DC source voltage is less than the second upper threshold. At least one of the first DC voltage and the second DC voltage is provided to the network protector control relay to provide power therefor.

The first voltage regulator and the second voltage regulator may be switching regulators, such as those that employ a Buck regulator topology. In addition, the switching mechanism may include a P-CHAN FET switch. The first DC voltage and the second DC voltage are preferably provided to an auctioneering stage, wherein at least one of the first DC voltage and the second DC voltage is provided to the network protector control relay by the auctioneering stage.

In the preferred embodiment, the first upper threshold is greater than the second upper threshold. In one particular embodiment, the second lower threshold is a DC voltage corresponding to an approximately 13 Vac input signal and the first upper threshold is a DC voltage corresponding to an approximately 190 Vac input signal, thereby establishing the operating range of the power supply.

The present invention also relates to a method of providing power to a network protector control relay over a relatively wide operating range. The method includes providing a rectified DC source voltage to a first voltage regulator having a first operating range and converting the rectified DC source voltage into a first DC voltage. The first operating range has a first lower threshold and a first upper threshold. The method further includes providing the rectified DC source voltage to a second voltage regulator having a second operating range having a second lower threshold and a second upper threshold and converting the rectified DC source voltage into a second DC voltage only if the rectified DC source voltage is less than the second upper threshold. Finally, the method includes providing at least one of the first DC voltage and the second DC voltage to the network protector control relay. Preferably, the step of providing at least one of the first DC voltage and the second DC voltage to the network protector control relay comprises auctioneering the first DC voltage and the second DC voltage.

### BRIEF DESCRIPTION OF THE DRAWINGS

A full understanding of the invention can be gained from the following description of the preferred embodiments when read in conjunction with the accompanying drawings in which:

FIG. 1 is a block diagram of a two-stage, wide range power supply for a network protector control relay according to the present invention; and

FIG. 2 is a circuit diagram of one particular implementation of the two-stage, wide range power supply shown in FIG. 1.

### DESCRIPTION OF THE PREFERRED EMBODIMENTS

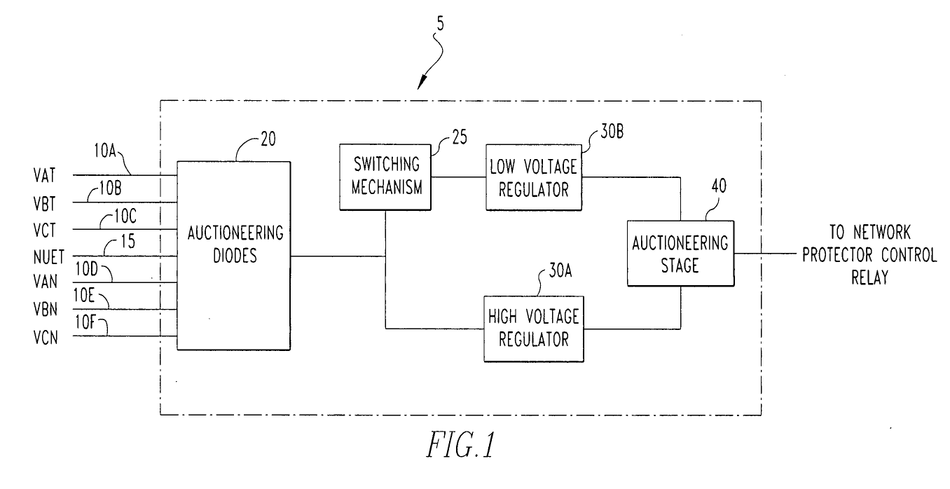

FIG. 1 is a block diagram of a power supply 5 according to the present invention that is capable of operating over a wide range of input voltages, such as, with limitation, a range from about 13 Vac single phase to about 190 Vac three phase. As seen in FIG. 1, transformer voltage lines 10A, 10B, 10C and network voltage lines 10D, 10E, and 10F, which are operatively coupled to the individual phases of the network feeder system voltage reducing transformer (not shown) and the network power bus, respectively, and neutral line 15 are input into power supply 5. Transformer voltage lines 10A, 10B, 10C and network voltage lines 10D, 10E, and 10F are operatively coupled to the individual phases of the network feeder system voltage reducing transformer (not shown) and the network power bus, respectively, such that phase to neutral or phase to phase voltage may be used as an input ac voltage supply for power supply 5. In particular, transformer voltage lines 10A, 10B, 10C, network voltage lines 10D, 10E, and 10F, and neutral line 15 are input into a bank of auctioneering diodes 20 which, as is known in the art, acts as a functional OR gate outputting a rectified (“raw”) DC voltage signal from the phase line to line (10A, 10B, 10C, 10D, 10E, and 10F) and phase line to neutral voltages to be used as a voltage source. The rectified DC voltage signal output by the bank of auctioneering diodes 20 is input into switching mechanism 25, the function of which is described below.

Power supply 5 further includes a pair of voltage regulators, namely high voltage regulator 30A and low voltage regulator 30B, each of which is adapted to take a raw DC voltage as an input and convert it into a substantially constant DC output voltage (which is used to power a network protector control relay). Preferably, high voltage regulator 30A and low voltage regulator 30B are each a switching regulator. As is known in the art, a switching regulator is a switching circuit that uses a closed-loop system to regulate output voltage, typically be means of a pulse-width modulator. Any type of known switching regulator may be employed in the present invention, such as, without limitation, a switching regulator employing a Buck regulator topology, a Boost regulator topology, a Buck-boost regulator topology, or a Flyback regulator topology.

High voltage regulator 30A is adapted to operate at a particular first (relatively high) range of input (into power supply 5) voltage values, and low voltage regulator 30B is adapted to operate at a particular second (relatively lower) range of input (into power supply 5) voltage values. Specifically, high voltage regulator 30A has a first operating range between a first lower threshold value (a DC value that corresponds to an AC input value) and a first upper threshold value (a DC value that corresponds to an AC input value), and low voltage regulator 30B has a second operating range between a second lower threshold value (a DC value that corresponds to an AC input value) and a second upper threshold value (a DC value that corresponds to an AC input value), wherein the first lower threshold value of the high voltage regulator 30A is greater than the second lower threshold value of the low voltage regulator 30B and wherein the second upper threshold value of the low voltage regulator 30B is equal to or greater than the first lower threshold value of the high voltage regulator 30A. For example, in one particular embodiment, the operating range of the high voltage regulator 30A is between approximately 20 Vac L-N and approximately 190 Vac L-N (input into power supply 5), and the operating range of the low voltage regulator 30B is between approximately 13 Vac L-N and approximately 25 Vac L-N (input into power supply 5). As will be appreciated, these values will translate into particular DC upper and lower threshold values for the high voltage regulator 30A and the low voltage regulator 30B.

As seen in FIG. 1, the rectified DC voltage signal output by the bank of auctioneering diodes 20 is provided to both the high voltage regulator 30A and a switching mechanism 25. The switching mechanism 25 is adapted to monitor the voltage output by the bank of auctioneering diodes 20. When the rectified DC voltage signal output by the bank of auctioneering diodes 20 is above a particular level, namely the second upper threshold value of the low voltage regulator 30B, the switching mechanism prevents the rectified DC voltage signal output by the bank of auctioneering diodes 20 from being provided to the low voltage regulator 30B, and when the rectified DC voltage signal output by the bank of auctioneering diodes 20 is at or below the particular level, the switching mechanism 25 causes the rectified DC voltage signal output by the bank of auctioneering diodes 20 to be provided to the low voltage regulator 30B. The switching mechanism 25 may comprise, for example, a P-CHAN FET switch that is caused to be in an open position when the voltage output by the bank of auctioneering diodes 20 is above the particular level and that is caused to move to a closed position when the voltage output by the bank of auctioneering diodes 20 is at or below the particular level.

Thus, with the configuration shown in FIG. 1, the rectified DC voltage signal output by the bank of auctioneering diodes 20 will be provided to only the high voltage regulator 30A when that voltage is higher than the upper operating limit (the second upper threshold value) of the low voltage regulator 30B, and will be provided to both the high voltage regulator 30A and the low voltage regulator 30B when that voltage is within the operating range of the low voltage regulator 30B. In addition, when the voltage output by the bank of auctioneering diodes 20 falls below the operating range of (below the value of the first lower threshold) of the high voltage regulator 30A, the high voltage regulator 30A will no longer be operative, and only the low voltage regulator 30B will be operative (even though the voltage is still provided to both). Furthermore, depending upon the degree of overlap of the first operating range of the high voltage regulator 30A and the second operating range of the low voltage regulator 30B (i.e., the first lower threshold relative to the second upper threshold), at certain rectified DC voltage signal levels output by the bank of auctioneering diodes 20, both the high voltage regulator 30A and the low voltage regulator 30B will be operative. The outputs (each a DC voltage) of the high voltage regulator 30A and the low voltage regulator 30B are combined in electrical parallel by auctioneering stage 40, yielding a regulated output DC bus. As is known in the art, auctioneering stage 40 functions to cause the highest of the two sources (a regulated DC voltage) to be provided to the network protector control relay (not shown) to provide operating power.

Thus, by providing two voltage regulators 30A, 30B having different operating ranges (preferably overlapping one another to some degree), power supply 5 according to the present invention is capable of operating over a relatively wide range of input voltages, i.e., ranging from an ac input voltage corresponding to the second lower threshold value of the low voltage regulator 30B to an ac input voltage corresponding to the first upper threshold value of the high voltage regulator 30A. This relatively wide range of input voltages will be greater than the range that may be utilized by prior art power supplies which employ a single, more limited range, voltage regulator to generate DC output voltages.

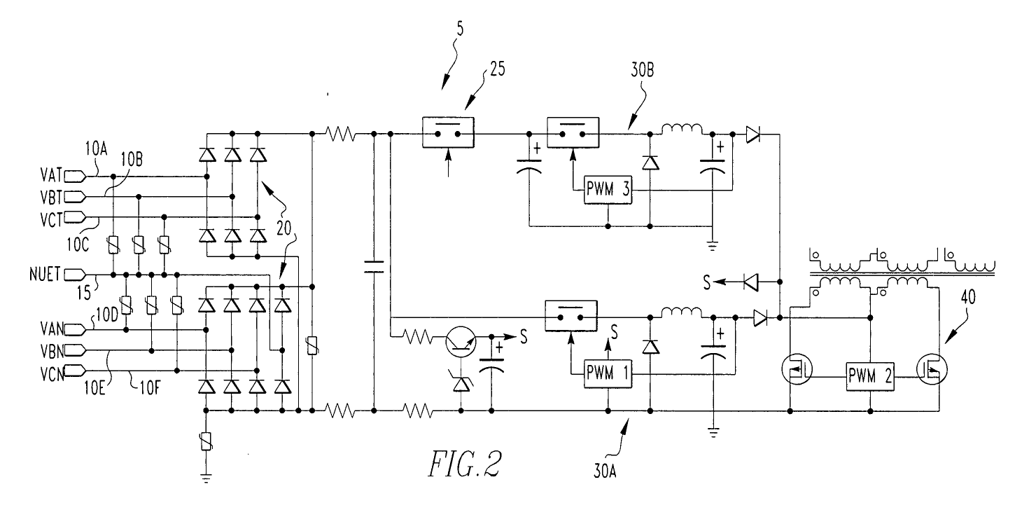

FIG. 2 is a circuit diagram showing one particular embodiment of power supply 5 according to the present invention. As seen in FIG. 2, switching mechanism 25 includes a P-CHAN FET switch driven by the output of a voltage comparator circuit, and both high voltage regulator 30A and low voltage regulator 30B utilize a Buck regulator topology employing a pulse-width modulator.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A power supply for a network protector control relay, comprising:
a first voltage regulator having a first operating range, said first operating range having a first lower threshold and a first upper threshold, wherein a rectified DC source voltage is provided to said first voltage regulator, said first voltage regulator converting said rectified DC source voltage into a first DC voltage;
a switching mechanism having a first condition and a second condition, wherein said rectified DC source voltage is provided to said switching mechanism; and
a second voltage regulator having a second operating range, said second operating range having a second lower threshold and a second upper threshold, said second voltage regulator being operatively coupled to said switching mechanism, wherein said rectified DC source voltage is provided to said second voltage regulator when said switching mechanism is in said second condition and is not provided to said second voltage regulator when said switching mechanism is in said first condition, said second voltage regulator converting said rectified DC source voltage into a second DC voltage;
wherein said switching mechanism is adapted to be in said first condition when said rectified DC source voltage is greater than said second upper threshold and in said second condition when said rectified DC source voltage is less than said second upper threshold, and wherein at least one of said first DC voltage and said second DC voltage is provided to said network protector control relay.

2. The power supply according to claim 1, wherein said first voltage regulator and said second voltage regulator are switching regulators.

3. The power supply according to claim 2, wherein said first voltage regulator and said second voltage regulator are switching regulators employing a Buck regulator topology.

4. The power supply according to claim 1, wherein said first upper threshold is greater than said second upper threshold.

5. The power supply according to claim 4, wherein said second lower threshold is a DC voltage corresponding to an approximately 13 Vac input signal and said first upper threshold is a DC voltage corresponding to an approximately 190 Vac input signal.

6. The power supply according to claim 5, wherein said first lower threshold is a DC voltage corresponding to an approximately 20 Vac input signal and said second upper threshold a DC voltage corresponding to an is approximately 25 Vac input signal.

7. The power supply according to claim 1, wherein said switching mechanism includes a P-CHAN FET switch.

8. The power supply according to claim 1, wherein said first DC voltage and said second DC voltage are provided to an auctioneering stage, and wherein at least one of said first DC voltage and said second DC voltage is provided to said network protector control relay by said auctioneering stage.

9. A method of providing power to a network protector control relay, comprising:
providing a rectified DC source voltage to a first voltage regulator having a first operating range, said first operating range having a first lower threshold and a first upper threshold, and converting said rectified DC source voltage into a first DC voltage;
providing said rectified DC source voltage to a second voltage regulator having a second operating range, said second operating range having a second lower threshold and a second upper threshold, and converting said rectified DC source voltage into a second DC voltage only if said rectified DC source voltage is less than said second upper threshold; and
providing at least one of said first DC voltage and said second DC voltage to said network protector control relay.

10. The method according to claim 9, wherein said first upper threshold is greater than said second upper threshold.

11. The method according to claim 10, wherein said second lower threshold is a DC voltage corresponding to an approximately 13 Vac input signal and said first upper threshold is a DC voltage corresponding to an approximately 190 Vac input signal.

12. The method according to claim 11, wherein said first lower threshold is a DC voltage corresponding to an approximately 20 Vac input signal and said second upper threshold is a DC voltage corresponding to an approximately 25 Vac input signal.

13. The method according to claim 9, wherein said step of providing at least one of said first DC voltage and said second DC voltage to said network protector control relay comprises auctioneering said first DC voltage and said second DC voltage.
